(19) United States
(12) Patent Application Publication
(10) Pub. No.: US 2026/0301411 A1
(43) Pub. Date: Oct. 1, 2026

(54) METHOD, APPARATUS AND SYSTEM FOR PREDICTING PROTECTIVE EQUIPMENT WEARING ON PERSON

(71) Applicant: NEC Corporation, Tokyo (JP)

(72) Inventors: Jiyan WU, Singapore (SG); Masafumi WATANABE, Tokyo (JP)

(73) Assignee: NEC Corporation, Tokyo (JP)

(21) Appl. No.: 19/477,242

(22) PCT Filed: May 1, 2024
(86) PCT No.: PCT/JP2024/016743

§ 371 Date: Oct. 21, 2025

(30) Foreign Application Priority Data
May 25, 2023 (SG) 10202301485T

(51) Int. Cl. G06V 20/52

(52) U.S. Cl. CPC G06V 20/52

(57) ABSTRACT

The present disclosure provides a method, an apparatus and a system for predicting whether a person is wearing a protective equipment. The method comprises: identifying at least one feature between a person and a protective equipment in connection with the person based on appearances of the person and the protective equipment detected within a monitoring area corresponding to a field of view of an image capturing apparatus over a time period; and generating a prediction result on whether the person is wearing the protective equipment based on the at least one feature.

### TECHNICAL FIELD

The present disclosure relates to protective equipment prediction method, apparatus, and more particularly, relates to a method, an apparatus and a system for predicting whether a person is wearing a protective equipment.

### BACKGROUND ART

Wearing personal protective equipment (PPE) is to guarantee the healthy and safety of workers/staffs in different working locations such as construction sites, military fields. Therefore, a PPE wearing checking is important to be implemented in working places. With wide deployment of surveillance cameras and technical advances in artificial intelligence (AI), it is interesting to study the problem of automatic PPE wearing check using vision analytic based solutions. The checking system outputs the result on whether the target person(s) wearing PPE or not. In such vision analytic based PPE wearing check systems, the accuracy and the AI model/algorithm is vitally important to guarantee working efficiency.

However, in the existing vision-based PPE wearing checking systems, the decision making is normally by the object detection/identification based on the single image itself captured from the surveillance camera. The accuracy of such static decision making cannot be guaranteed because there may be issues in the actual system running environments such as occlusion/overlapping of a person or a PPE and video/image quality, camera angle, poor or changing lighting condition, changing background color and performance limitation of deep learning model.

There is thus a need that provide a method, an apparatus and a system for predicting whether a person is wearing a protective equipment to address the above challenges where object recognition and tracking models are applied to detect dynamic appearances of the person and the protective equipment and their trajectories within a monitoring area over a time period to generate a more accurate prediction result on whether the person is wearing the PPE especially in changing environments. Furthermore, other desirable features and characteristics will become apparent from the subsequent detailed description and the appended claims, taken in conjunction with the accompanying drawings and this background of the disclosure.

### SUMMARY OF INVENTION

In a first aspect, the present disclosure provides a method for predicting whether a person is wearing a protective equipment, the method comprising: identifying at least one feature between a person and a protective equipment in connection with the person based on appearances of the person and the protective equipment detected within a monitoring area corresponding to a field of view of an image capturing apparatus over a time period; and generating a prediction result on whether the person is wearing the protective equipment based on the at least one feature.

In a second aspect, the present disclosure provides an apparatus for predicting whether a person is wearing a protective equipment, the apparatus comprising: at least one processor; and at least one memory including computer program code; the at least one memory and the computer program code configured to, with at least one processor, cause the apparatus at least to: identify at least one feature between a person and a protective equipment in connection with the person based on appearances of the person and the protective equipment detected within a monitoring area corresponding to a field of view of an image capturing apparatus over a time period; and generate a prediction result on whether the person is wearing the protective equipment based on the at least one feature.

In a third aspect, the present disclosure provides a system for predicting whether a person is wearing a protective equipment comprising the apparatus according to the second aspect and an image capturing apparatus with a field of view corresponding to the monitoring area within which the appearances of the person and the protective equipment are detected.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

Embodiments of the disclosure will be better understood and readily apparent to one of ordinary skill in the art from the following written description, by way of example only, and in conjunction with the drawings, in which:

FIG. 1 shows a diagram illustrating a conventional protective equipment wearing checking system.

FIG. 2 shows a flow chart illustrating a method for predicting whether a person is wearing a protective equipment according to various embodiments of the present disclosure.

FIG. 3 shows a block diagram illustrating a system for predicting whether a person is wearing a protective equipment according to various embodiments of the present disclosure.

FIG. 4 shows a diagram illustrating a monitoring area corresponding to a field of view of a camera according to an embodiment of the present disclosure.

FIG. 5 shows a flowchart illustrating a process for predicting whether a person is wearing a protecting equipment according to an embodiment.

FIG. 6 shows a diagram illustrating tracking trajectories of a person and a PPE for predicting whether the person is wearing the PPE according to an embodiment of the present disclosure.

FIG. 7 shows a diagram illustrating an overlapping area between a person and a PPE according to an embodiment of the present disclosure.

FIG. 8 shows a diagram illustrating various detection points of a person and a PPE to determine a probability relating to an appearance frequency of the person and the PPE according to an embodiment of the present disclosure.

FIG. 9 shows a flowchart illustrating a process for predicting whether a person is wearing a PPE according to an embodiment of the present disclosure.

FIG. 10 shows a diagram illustrating a process to train a detection model for predicting whether a person is wearing a PPE according to an embodiment of the present disclosure.

FIG. 11 shows a block diagram illustrating an architecture of a LSTM neural network structure according to an embodiment of the present disclosure.

FIG. 12 shows an exemplary positive sample for training a detection model for predicting whether a person is wearing a PPE.

FIG. 13 shows an exemplary negative sample for training a detection model for predicting whether a person is wearing a PPE.

FIG. 14 shows a flowchart illustrating a rule-based process for predicting whether a person is wearing a PPE according to an embodiment of the present disclosure.

FIG. 15 shows a schematic diagram of an exemplary computing device suitable for use to execute the method in FIG. 2 and implement the apparatus in FIG. 3.

### DESCRIPTION OF EMBODIMENTS

### Overview

Embodiments of the present disclosure will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “calculating”, “determining”, “updating”, “generating”, “initializing”, “outputting”, “receiving”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Various embodiments of the present disclosure relate to a method and an apparatus for predicting whether a person is wearing a protective equipment. It is appreciated by a skilled person that such apparatus and the at least one video capturing apparatus may be implemented as part of a system to provide the same technical effect.

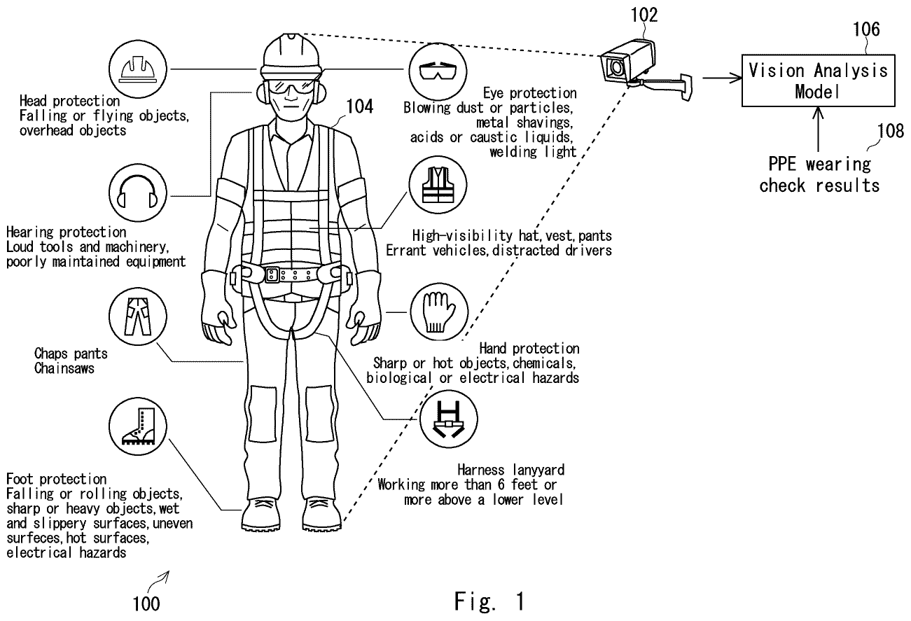

FIG. 1 shows a diagram 100 illustrating a conventional protective equipment wearing checking system. The protective equipment system comprises a camera 102 configured to detect an appearance of a person 104 in an image. The image is processed by a vision analysis model 106 to generate a result on whether the person 104 is wearing a personal protective equipment (PPE).

As mentioned earlier, the conventional protective equipment wearing checking system utilizes static decision making based on detection of the person and his/her PPE from the image itself captured by the camera. Such static decision making relies heavily on the actual system running environment and settings (e.g., camera angle, lighting condition, background color, etc.) in order to work reliability. Additionally, the accuracy of the PPE detection may be affected by the following issues:
Occlusion/Overlapping: This problem often happens when multiple persons walk together within the camera field of view. The PPE of one person may be blocked by the other person. Or even one person is completely blocked by the other person. In such case, the static image based detection incurs false/missing predictions.
Video/image blue: This video/image blur refers to the image quality problem that may be caused by different reasons like fast moving person, lighting condition, person image resolution, etc. As a result, the person image quality is not enough for the vision model to make accurate predictions.

It is thus an object to provide a method, an apparatus and a system for predicting whether a person is wearing a protective equipment or PPE to address the above challenges, for example, by applying object recognition and tracking models to detect dynamic appearances of the person and the protective equipment and their trajectories within a monitoring area over a time period to generate a more accurate prediction result on whether the person is wearing the PPE. The accuracy will be less susceptible to actual running environment and the method, apparatus and system can easily be applied in changing environments.

In various embodiments below, the term “protective equipment” can be used interchangeably with the term “personal protective equipment” or “PPE”.

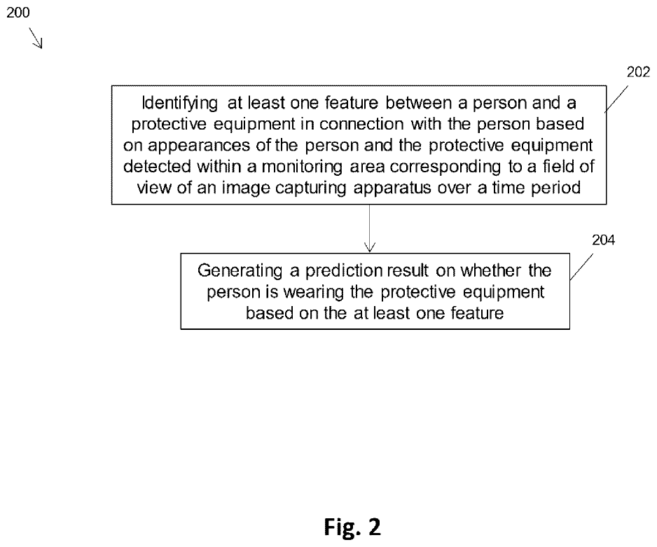

FIG. 2 shows a flow chart 200 illustrating a method for predicting whether a person is wearing a protective equipment according to various embodiments of the present disclosure. In step 202, a step of identifying at least one feature between a person and a protective equipment in connection with the person is carried out based on appearances of the person and the protective equipment detected within a monitoring area corresponding to a field of view of an image capturing apparatus over a time period. In step 204, a step of generating a prediction result on whether the person is wearing the protective equipment is carried out based on the at least one feature.

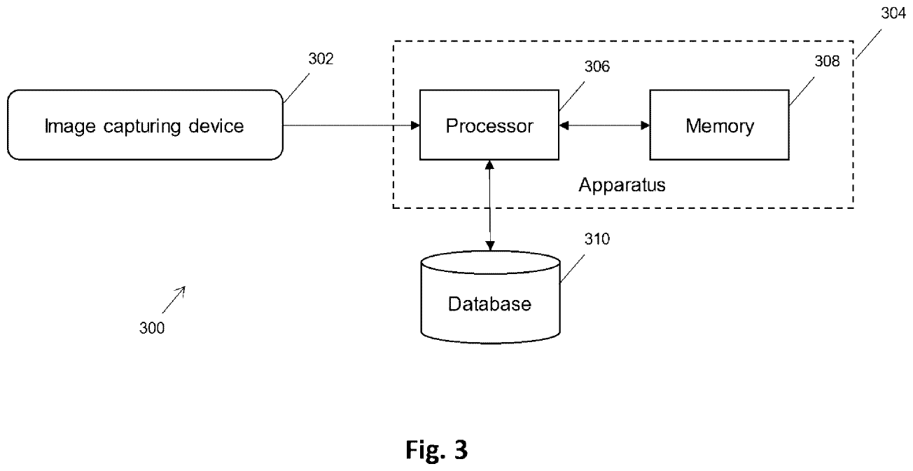

FIG. 3 shows a block diagram illustrating a system 300 for predicting whether a person is wearing a protective equipment according to various embodiments of the present disclosure.

The managing of image or video input is performed by at least one image capturing device 302 and an apparatus 304. For the sake of simplicity, only one image capturing device 302 is illustrated. The system 300 comprises an image capturing device 302 in communication with the apparatus 304. In an implementation, the apparatus 304 may be generally described as a physical device comprising at least one processor 306 and at least one memory 308 including computer program code. The at least one memory 308 and the computer program code are configured to, with the at least one processor 306, cause the physical device to perform the operations described in FIG. 2. The processor 306 is configured to receive one or more images or videos from the image capturing device 302 or retrieve one or more images or videos from a database. Alternatively or additionally, the one or more images or videos captured by the image capturing device 302 is stored in a database 310, and the processor 306 is configured to retrieve the one or more images or videos from the database 310.

The image capturing device 302 may be a device such as a closed-circuit television (CCTV) which provides a variety of data such as data relating to an appearance and/or a movement of one or more body part of a person and/or an appearance and/or a movement of a protective equipment in connection with (worn on, held on or near to one or more body part of) the person to predict whether the person is wearing the protective equipment. In an implementation, appearance data derived from the video capturing device 302 may be stored in memory 308 of the apparatus 304 or a database 310 accessible by the apparatus 304. The data may include (i) facial feature data such as relative position, size, shape and/or contour of eyes, nose, cheekbones, jaw and chin, and also iris pattern, skin colour, hair colour or a combination thereof, (ii) physical characteristic data such as height, body size, body ratio, length of limbs, hair colour, skin colour, apparels, belongings, equipment, equipment length/weight/height, equipment colour, other similar characteristics or combinations, and (iii) behavioral characteristic data such as movement, position of limbs, position of apparel/belonging/equipment, direction of movement, differential in movement direction, moving speed, frequency, movement patterns, the way or the time period a person or his/her body part stay stills or moves, other similar characteristics or combinations.

In an implementation, camera data such as location and resolution, and/or time data which includes a timestamp at which the one or more persons are identified may also be derived from the image capturing device 302. The camera data and/or time data may be stored in memory 308 of the apparatus 304 or a database 310 accessible by the apparatus 304 and the processor 306 is configured to identify and retrieve data, image or video based on the time data. It should be appreciated that the database 310 may be a part of the apparatus 304.

The apparatus 304 may be configured to communicate with the image capturing device 302 and the database 310. In an example, the apparatus 304 may receive, from the video capturing device 302, or retrieve from the database 310, one or more images or videos of a monitoring area corresponding to a field of view of the image capturing device 302, within which appearances of a person and a protective equipment are detected.

According to the present disclosure, the memory 308 and the computer program code stored therein are configured to, with the processor 306 cause the apparatus 304 to identify at least one feature between a person and a protective equipment in connection with the person based on appearances of the person and the protective equipment detected within the monitoring area over a time period, and generate a prediction result on whether the person is wearing the protective equipment based on the at least one feature.

The memory 308 and the computer program code stored therein are configured to, with the processor 306 cause the apparatus 304 to detect a first trajectory of the person and a second trajectory of the protective equipment within the monitoring area based on the appearances of the person and the protective equipment, determine a level of similarity between the first and second trajectories (hereinafter may referred to as “trajectory similarity level”), and generate the prediction result based on the level of similarity.

The memory 308 and the computer program code stored therein are configured to, with the processor 306 cause the apparatus 304 to calculate a probability relating to an appearance frequency of each of the person and the protective equipment (hereinafter may referred to as “occurrence probability”) based on a first count of appearances of the person and a second count of appearance of the protective equipment within the monitoring area over the time period, and generate the prediction result based on the probability.

The memory 308 and the computer program code stored therein are configured to, with the processor 306 cause the apparatus 304 to determine if an overlapping area between the person and the protective equipment is at or close to a body part of the person (hereinafter may referred to as “area overlapping”) and generate the prediction result based on a result of the determination of the overlapping area.

The memory 308 and the computer program code stored therein are configured to, with the processor 306 cause the apparatus 304 to apply a weightage to a value of each of the at least one feature; and generate the prediction result based on the weighted value of the each of the at least one feature.

The memory 308 and the computer program code stored therein are configured to, with the processor 306 cause the apparatus 304 to receive a training value of the each of the at least one feature between a known person (or a person previously identified and recognized) and a protective equipment in connection with the known person and a label indicating whether the known person is wearing the protective equipment, apply an initial weightage to the training value, generate an initial prediction result based on the weighted training value, determine if the initial prediction result matches the label, and adjust the initial weightage to the weightage to be applied to the value of the each of the at least one feature in response to a result of the determination of the initial prediction result.

The memory 308 and the computer program code stored therein are configured to, with the processor 306 cause the apparatus 304 to increase a count of protective equipment detected over the time period based on the prediction result, determine a count of protective equipment is less than a predetermined number of protective equipment over the time period, and generate an alert in response to determining the count of protective equipment is less than the count of persons detected over the time period.

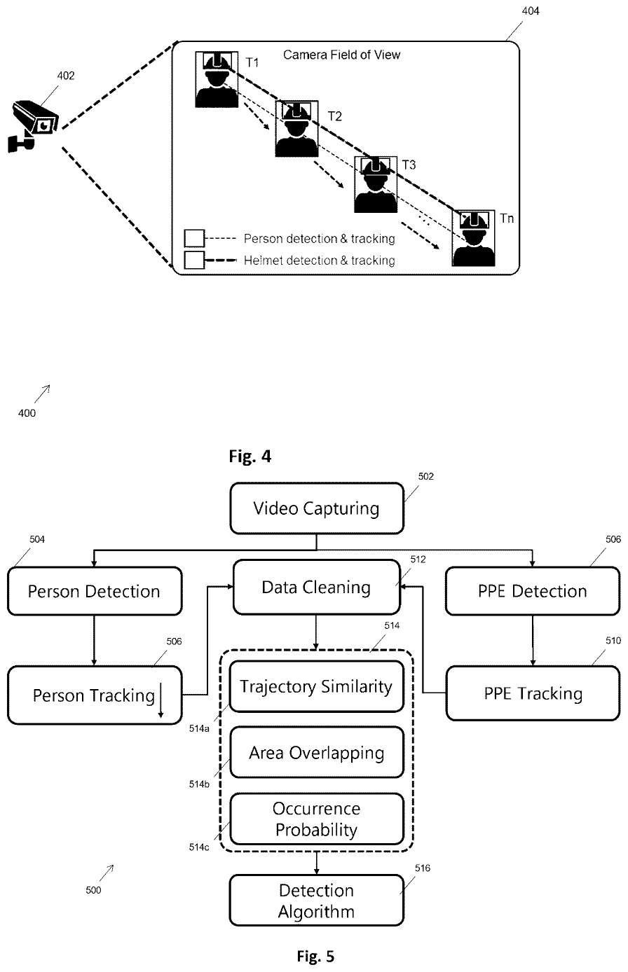

FIG. 4 shows a diagram 400 illustrating a monitoring area 404 corresponding to a field of view of a camera 402 according to an embodiment of the present disclosure. In this embodiment, during a time period from T1-T4, four appearances of a person and an PPE worn by the person are detected and their trajectories are tracked within the monitoring area 404. Such person and object recognition and tracking to detect multiple appearances of the person and the PPE as well as their trajectories over a time period, and allows an automatic and more accurate PPE detection and prediction in changing environments. More details will be elaborated in the following paragraphs.

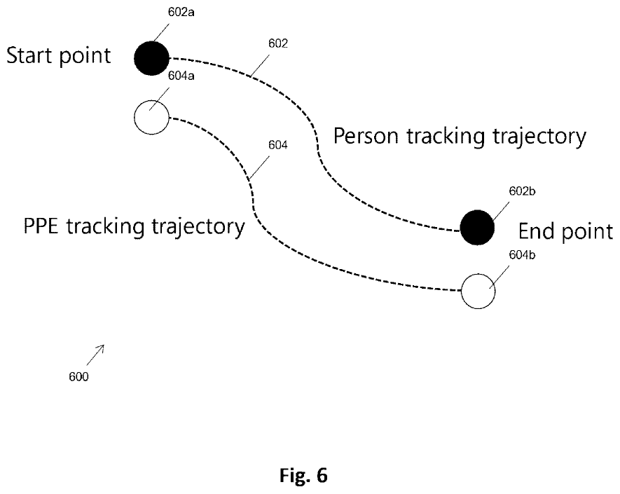

FIG. 5 shows a flowchart 500 illustrating a process for predicting whether a person is wearing a protecting equipment according to an embodiment. The process starts from step 502. In step 502, a video is captured and both steps 504, 506 are carried out. In step 504, a person is detected from the video; while in step 506, a PPE is detected from the video. Subsequent to step 504, in step 508, the trajectory of the person is tracked over a time period (e.g., a duration of the video) based on subsequent appearances of the person in the video. Subsequent to step 506, in step 510, the trajectory of the PPE is tracked over the same time period based on subsequent appearances of the PPE in the video. In step 512, the tracking results and data are cleaned before being processed by a processor or processing unit in step 514.

In step 514, additional or fewer steps may be involved than illustrated. For example, one or more of step 514a, 514b, 514c may be omitted in step 514. In step 514a, a step of determine a level of similarity between the trajectory of the person and the trajectory of the PPE may be carried out. In step 514b, a step of determining if an overlapping area between the person and the PPE is at or close to a body part (e.g., head or hand) of the person. In step 514c, a step of calculating a probability relating to an appearance frequency of each of the person and the protective equipment based on a first count of appearances of the person and a second count of appearance of the PPE within the monitoring area over the time period.

In step 516, a detection algorithm is utilized to detect and predict whether the person is wearing the PPE based on the results generated in step 514. For example, in step 514a, the trajectory similarity level is based on the dynamic moving feature of the person and the PPE. Assuming that the person is always wearing the PPE, then the two trajectories of the person and the PPE share high level of similarity.

The determination of the overlapping area in step 514b may be useful to improve the reliability of the detection and decision. For example, while a helmet should be worn on head, the trajectory of the helmet on hand also share high level of similarity with the person's trajectory. In this case, determining an overlapping area between the person and the helmet is on the head or hand will be useful to detect whether the person is wearing the PPE or not.

The calculated probability, which correlates to whether frequency of the person being detected matches the frequency of the PPE being detected within the same time period, may also be useful to improve the detection, decision and prediction reliability. For example, if the person is detected 10 times while the PPE is detected 11 times within the same 1-minute period, it can be predicted that the PPE is in connection with the person and the person is wearing PPE. If, however, there is a huge discrepancy between the appearance/detection frequency of the person and the PPE, for example, the person is detected 10 times within the 1-minute period while the PPE is detected once within the same 1-minute period, it can be predicted that the person is not wearing the PPE.

Additionally, the detection algorithm used in step 516 may use a time-series analysis model which is trained by various positive and negative sample videos to accommodate different situation and environments (e.g., different lighting conditions, background color, camera angle) so that reliability results can be generated using video captured under various changing environments.

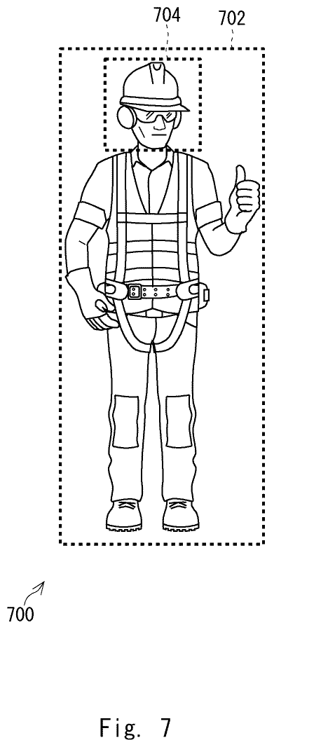

FIG. 6 shows a diagram 600 illustrating tracking trajectories of a person and a PPE for predicting whether the person is wearing the PPE according to an embodiment of the present disclosure. Appearances of a person are detected and tracked over a time period. The points of detection of the person may be connected according to the time points the appearances are detected to form a person tracking trajectory 602, [[0.13, 0.72], [0.14, 0.76], . . . , [0.47, 0.72]], within a monitoring area, as shown using the line connecting a starting appearance detection point 602a to an ending appearance detection point 602b. Such points of detection may be in the form of x-y coordinates or other position/point identifier.

Similarly, over the same time period, appearances of a PPE are detected and tracked and the points of detection of the PPE may be connected according to the time points at which the appearances are detected to form a PPE tracking trajectory 604, [[0.16, 0.74], [0.17, 0.73], . . . , [0.53, 0.78]], within the monitoring area, as shown in the line connecting a staring appearance detection point 604a and an ending appearance detection 604b.

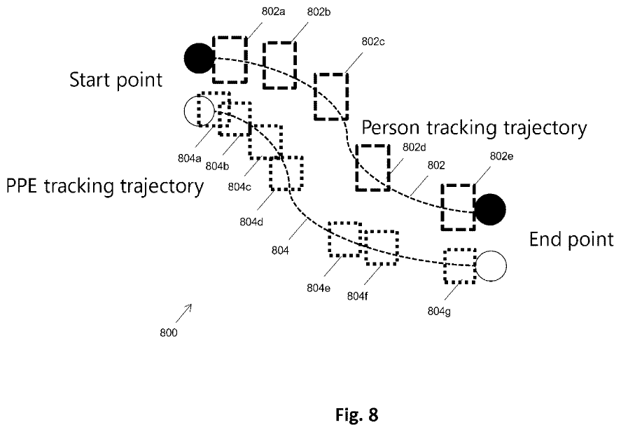

FIG. 7 shows a diagram 700 illustrating an overlapping area between a person and a PPE according to an embodiment of the present disclosure. A person bounding box 702 and a PPE bounding box 704 are detected within the monitoring area from the image. The position of an overlapping area is determined using the following equation (1):

$$Overlaping area = Intersection / Union \qquad equation ( 1 )$$

where the intersection refers to the area where the PPE bounding box and person bounding box intersect and union refers to the area both PPE bounding box and person bounding box occupy within the monitoring area.

In this embodiment, the PPE is a helmet and the overlapping area is near the head of the person. Hence, it may be determined that the person is wearing the PPE. Alternatively, if the overlapping area is near the hand of the person, it is determined that the person is not wearing the PPE.

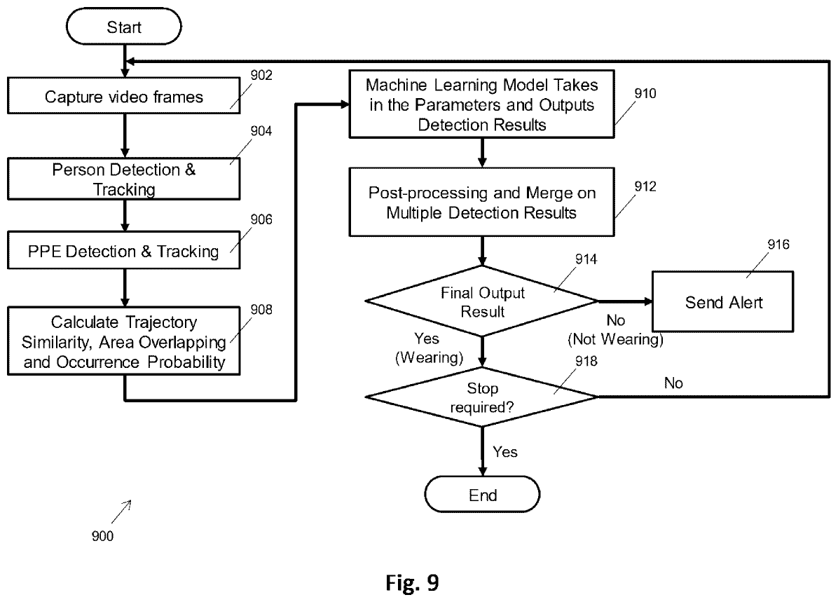

FIG. 8 shows a diagram 800 illustrating various detection points of a person and a PPE to determine a probability relating to an appearance frequency of the person and the PPE according to an embodiment of the present disclosure. A total of five appearances of the person are detected within a time period and the corresponding five detection points of the person during his/her movement within the monitoring area 802a-802e are connected to form a person tracking trajectory 802. A total of seven appearances of the PPE are detected within the same time period and the corresponding seven detection points of the PPE during its movement within the monitoring area 804a-804g are connected to form a PPE tracking trajectory 804. Such count of appearances of the person and the PPE are used to determine a probability (or hereinafter referred to as occurrence probability) relating the appearance frequencies of the person and the PPE to detect and predict wither the person is wearing the PPE. In one example, the probability is calculated using the following equation (2):

$$Probability = \frac{count of detections of PPE during movement}{count of detections of person during movement} \qquad equation ( 2 )$$

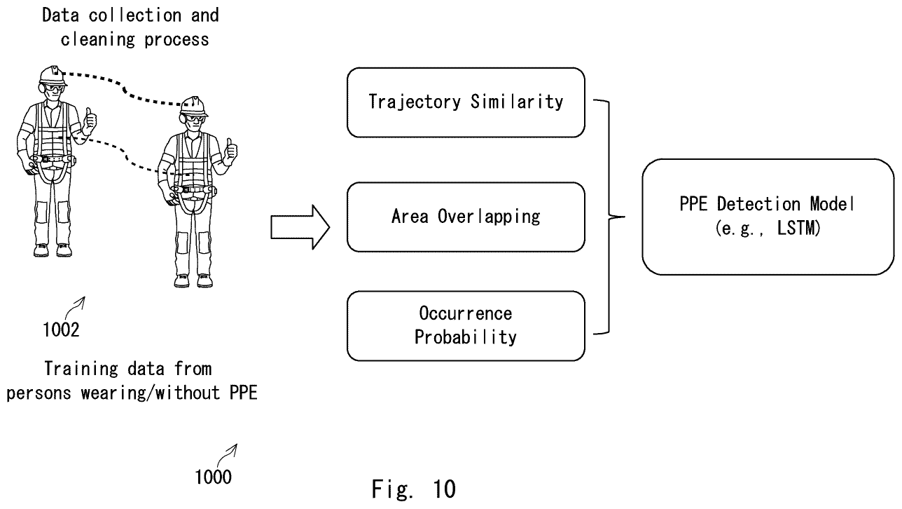

FIG. 9 shows a flowchart 900 illustrating a process for predicting whether a person is wearing a PPE according to an embodiment of the present disclosure. In step 902, a step of capturing video frames from a video is caried out. In step 904, a step of detecting and tracking a person from the video frames is carried out. In step 906, a step of detecting and tracking a PPE from the video frames is carried out. In step 908, a step of calculating and determining trajectory similarity, area overlapping and occurrence probability is carried out. In step 910, a machine learning model takes in the parameters generated from the calculation and determination step in step 908 and output determination result on whether the person is wearing the PPE. In step 912, post-processing and merging on multiple detection results on whether the person is wearing the PPE to generate a final output result in step 914. In step 914, if the final output result shows that the person is not wearing the PPE, step 916 is carried out where an alert is sent to alert the user. If the final output result shows that the person is wearing the PPE, step 918 is carried out. In step 918, it is determined whether it is required to stop the processing. If it is determined that it is not required to stop the processing, for example, no stop command is detected, step 902 is again carried out to capture new video frames to process through steps 904-914. If it is determined that a stop command is detected and thus it is required to stop the processing, the process may end.

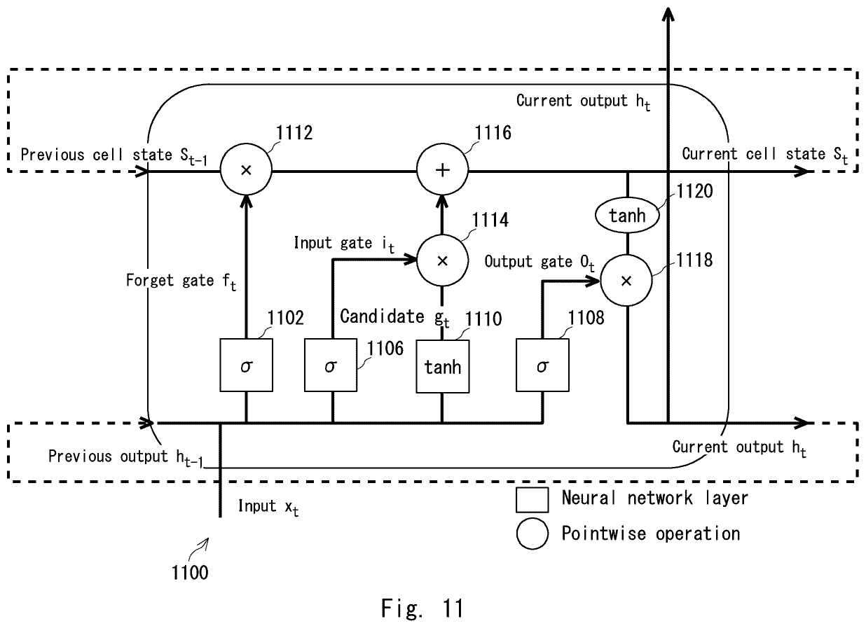

FIG. 10 shows a diagram 1000 illustrating a process to train a detection model for predicting whether a person is wearing a PPE according to an embodiment of the present disclosure. Positive and negative training data with labels “1” and “0” indicating known prediction result of a person (a previously known, identified or recognized person and assigned a person ID) is wearing a protective equipment or not, respectively, are used to train the detection model to predict whether a person (known or unknown) is wearing a PPE or not. For example, training data with label “1” corresponds to a positive sample in which a person is wearing a protective equipment and training data with label “0” corresponds to a negative sample in which a person is not wearing a protective equipment. The training data are received after a data collection and cleaning process and used to train the detection model. Such data are associated with values relating to at least one feature between the person and the protective equipment (hereinafter referred may to as training values) such as a level of similarity, an area overlapping and an occurrence probability, and such feature values together with the training data will be used for training the detection model to subsequently predict whether a person is wearing or is not wearing a PPE when encountering data associated with same or similar feature values in future.

The PPE wearing status check model may be a Long Short Term Memory (LSTM) model. Since the training and prediction data is time-series data, recurrent neural network such as LSTM proves to be effective on exploring the time and frequency domain features of such training data.

Table 1 shows an example training data and labels for training the detection model for predicting whether a person is wearing a PPE according to an embodiment of the present disclosure.

TABLE 1

| | | Trajectory | | | |
|---|---|---|---|---|---|
| Frame | Person | similarity | Area | Occurrence | |
| index | ID | level | overlapping | probability | Label |
| 1 | 1 | 0.67 | 0.87 | 0.98 | 1 |
| 2 | 1 | 0.72 | 0.76 | 0.83 | 1 |
| . . . | . . . | . . . | . . . | . . . | 1 |
| N | 1 | 0.67 | 0.87 | 0.98 | 1 |
| N + 1 | 1 | 0.43 | 0.57 | 0.32 | 0 |
| . . . | . . . | . . . | . . . | . . . | 0 |
| . . . | . . . | 0.48 | 0.62 | 0.42 | 0 |

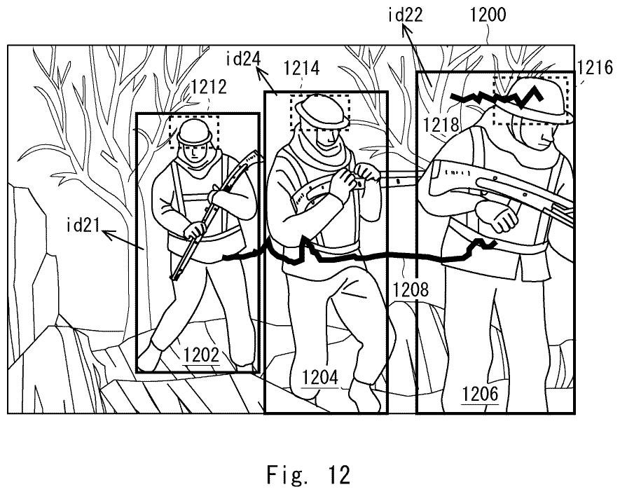

FIG. 11 shows a block diagram 1100 illustrating an architecture of a LSTM neural network structure according to an embodiment of the present disclosure. In this embodiment, the structure of the LSTM model comprises a forget gate, which collectively represented by blocks 1102, 1104, an input gate 1106, and an output gate 1108. In this embodiment, a processing of LSTM model takes in training data 1002 and its associated feature values relating to trajectory similarity level, area overlapping and occurrence probability.

In forward direction LSTM of the bidirectional LSTM layer 406, the processing of the LSTM layer 406 is carried out in a forward direction, i.e. with incremental t value. That is, after the processing at t-th data (and its feature values) is completed, the processing at (t+1)-th data will be carried out (if any). In a forward direction LSTM, the following equations is applied:

$${f}_{t} = σ ( {W}_{f} \cdot [ {h}_{t - 1} , {x}_{t} ] + {b}_{f} ) \qquad equation ( 3 )$$

$${i}_{t} = σ ( {W}_{i} \cdot [ {h}_{t - 1} , {x}_{t} ] + {b}_{i} ) \qquad equation ( 4 )$$

$${\tilde{C}}_{t} = tanh ( {W}_{C} \cdot [ {h}_{t - 1} , {x}_{t} ] + {b}_{C} ) \qquad equation ( 5 )$$

$${C}_{t} = {f}_{t} \times {C}_{t - 1} + {i}_{t} \times {\tilde{C}}_{t} \qquad equation ( 6 )$$

$${o}_{t} = σ ( {W}_{o} \cdot [ {h}_{t - 1} , {x}_{t} ] + {b}_{o} ) \qquad equation ( 7 )$$

$${h}_{t} = {o}_{t} \times tanh ( {C}_{t} ) \qquad equation ( 8 )$$

where xₜ is an input of training data at t-th position;
hₜ is a hidden state (output) of LSTM structure at t-th position;
Sₜ is a current cell state (output) of LSTM structure at t-th position;
hₜ₋₁ is a hidden state of LSTM structure at (t−1)-th position;
Sₜ₋₁ is a previous cell state of LSTM structure at (t−1)-th position;
Wₜ, Wᵢ, W_{c}, and Wₒ (not shown in FIG. 11) are convolution weights (variables) for a forget gate, an input gate, an estimated cell state, and an output gate respectively, optionally applied before σ and tanh; and
σ 1102, 1106, 1108 and tanh 1110 are sigmoid activation function and tanh activation function, respectively. A sigmoid function 1102, 1106, 1108 squishes values between 0 and 1 while a tanh activation function 1110 squishes values to always be between −1 and 1.

Previous output of input xₜ₋₁ (not shown)) and a current input xₜ from training data at t-th position is concatenated into an array or a vector of input at t-th position [hₜ₋₁, xₜ] (hereinafter referred to as input vector). The input vector is then sent to a forget gate. The forget gate determines which data and what extent of the data should be thrown away or kept by applying a first variable, e.g. a convolution weight W_{f} (not shown) and a sigmoid function σ 1102 to generate a value between 0 to 1. A sigmoid output value closer to 0 means to forget and a sigmoid output value closer to 1 means to keep. The sigmoid output is referred to a forget vector and will output for further cell state processing at 1112.

The input vector is also sent to the input gate. The input gate determine which values is important and will be updated. In the input gate, a second variable, e.g. a convolution weight Wᵢ (not shown) and a sigmoid function σ 1106, is applied to the input vector 505 to generate a value between 0 to 1. A value closer to 0 means not important and a value closer to 1 means important. A third variable, e.g. convolution weight W_{c} (not shown) and a tanh activation function σ 1110 is also applied to the input vector to squish values between −1 and 1. By multiplying the sigmoid output to the tanh output at 1114, the sigmoid output will determine which information is important to keep from the tanh output and form an output of the input gate for further cell state processing at 1116.

Regarding cell state, the previous cell state Sₜ₋₁ at (t−1)-th position (previous output of input xₜ₋₁ (not shown)) is processed through a multiplication by the forget vector at 1112. This will result in forgetting/keeping certain values in the cell state. Subsequently, the cell state is further processed through an addition by the output of the input gate and updates the cell state to a current cell state Sₜ at 1116. The new cell state generated at t-th position is output to the next LSTM structure for (t+1)-th position, i.e. data subsequent to the data at t-th position, to generate a new cell state Cₜ₊₁ and a new hidden state hₜ₊₁.

Noting the input vector comprises a current input xₜ at t-th position and previous hidden state at (t−1)th position hₜ₋₁, the input vector is also transferred to the output gate to determine what the next hidden state hₜ should be. In the output gate, a fourth variable, e.g. a convolution weight Wₒ (not shown) and a sigmoid function σ 1108 is applied to the input to generate a value between 0 to 1 at 1118. A tanh activation function 1120 is then applied to the new cell state. By multiplying the sigmoid output 1118 to the tanh output, the sigmoid output will determine which/what information the next hidden state hₜ should carry. A new hidden state hₜ is generated and then sent to the next LSTM processing for (t+1)-th position, i.e. a character subsequent to the character at t-th position, to generate a new cell state Cₜ₊₁ and a new hidden state hₜ₊₁.

In various embodiment, when training data with labels indicating known prediction outcome (e.g., a person is wearing a PPE, a person is not wearing a PPE) is input to neural network 1100, the variables, such as convolution weights Wₜ, Wᵢ, W_{c}, and Wₒ, (not shown) applied in the forget gate, the input gate, the estimated cell state and the output gate in the LSTM structure 1100 are optimized and modified to generate a sigmoid value corresponds to a prediction outcome that matches the known prediction outcome.

The neural network 1100 is continuously optimized with more training data over time to make better and more accurate predictions on whether a person is wearing a PPE.

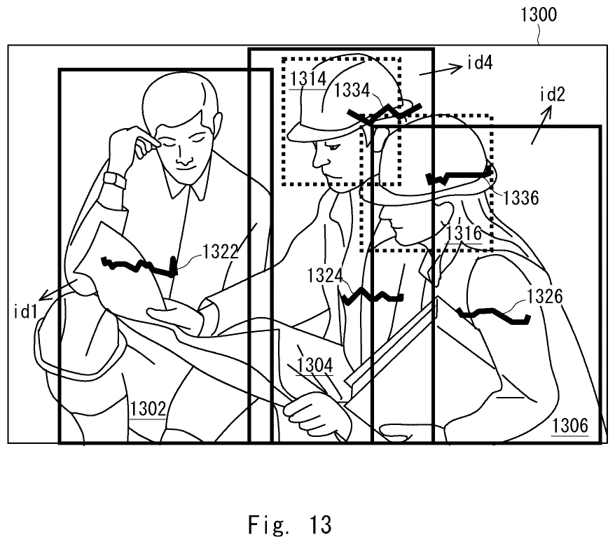

FIG. 12 shows an exemplary positive sample for training a detection model for predicting whether a person is wearing a PPE. The positive sample may contain a label “1” indicating a known outcome that a person(s) is wearing a PPE(s). The sample comprises a video 1200 with appearances of three known persons with assigned identifiers “21”, “22” and “24” occupying person detection bounding boxes 1202, 1204, 1206 within the video 1200 and appearances of three helmets in connection with the three persons occupying helmet detection bounding boxes 1212, 1214, 1216, respectively. A tracking trajectory of the persons 1208 and a tracking trajectory of the helmets 1218 over a time period can be determined. In an example, feature values such as the level of similarity of the tracking trajectories 1208, 1218, overlapping areas between the persons and helmets, occurrence frequencies of the persons and helmets over the time period and/or number of persons/helmets detected may be used by the detection model to generate a prediction result “1” or “0”, and such prediction result is then checked and determined whether it matches the label with the known outcome.

Table 2 shows an example training data of the positive sample illustrated in FIG. 12 and a prediction result generated by a PPE detection/prediction model according to an embodiment of the present disclosure.

TABLE 2

| | | Trajectory | | | |
|---|---|---|---|---|---|
| Frame | Person | similarity | Area | Occurrence | Prediction |
| index | ID | level | overlapping | probability | result |
| 0 | 22 | 0.63 | 0.82 | 0.98 | 1 |
| 1 | 22 | 0.73 | 0.67 | 0.85 | 1 |
| . . . | . . . | . . . | . . . | . . . | 1 |
| . . . | . . . | 0.72 | 0.72 | 0.69 | 1 |

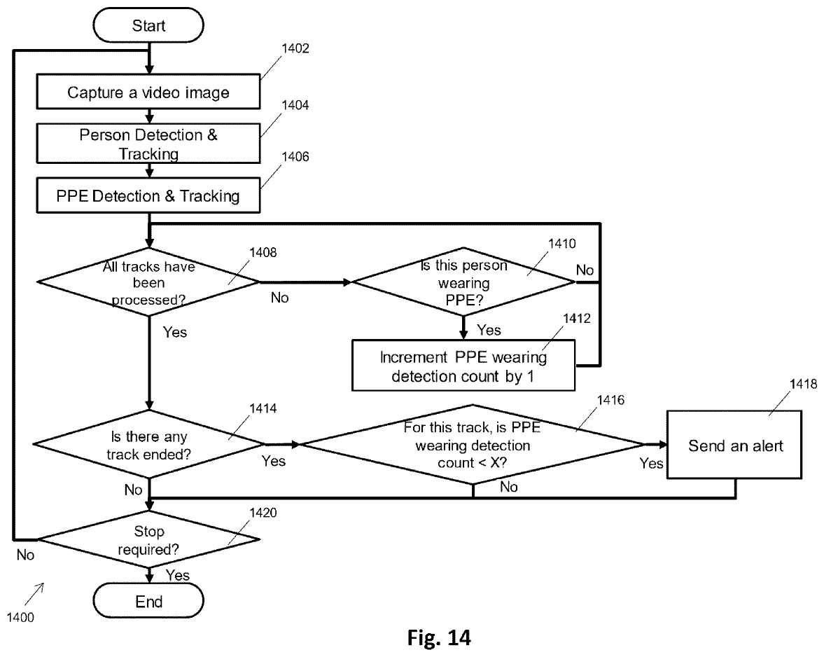

FIG. 13 shows an exemplary negative sample for training a detection model for predicting whether a person is wearing a PPE. The negative sample may contain a label “0” indicating a known outcome that a person(s) is not wearing a PPE(s). The sample comprises a video 1300 with appearances of three known persons with assigned identifiers “1”, “4” and “2” occupying person detection bounding boxes 1302, 1304, 1306, respectively and appearances of two helmets in connection with two persons from person detection bounding boxes 1304, 1306, the two helmets occupying helmet detection bounding boxes 1314, 1316, respectively. Tracking trajectories of the three persons 1322, 1324, 1326 and tracking trajectories of the two helmets 1334, 1336 over a time period can be determined. In an example, feature values such as the level of similarity of the tracking trajectories 1208, 1218, overlapping areas between the persons and helmets, occurrence frequencies of the persons and helmets over the time period and/or number of persons/helmets may be used by the detection model to generate a prediction result, and such prediction result is then checked and determined whether it matches the label with the known outcome.

Table 3 shows an example training data of the negative sample illustrated in FIG. 12 and a prediction result generated by a PPE detection/prediction model according to an embodiment of the present disclosure.

TABLE 3

| | | Trajectory | | | |
|---|---|---|---|---|---|
| Frame | Person | similarity | Area | Occurrence | Prediction |
| index | ID | level | overlapping | probability | result |
| 0 | 1 | 0.32 | 0.27 | 0.28 | 0 |
| 1 | 1 | 0.43 | 0.27 | 0.35 | 0 |
| . . . | . . . | . . . | . . . | . . . | 0 |
| . . . | . . . | 0.39 | 0.27 | 0.46 | 0 |

In one embodiment, a weightage stored in a database (not shown) assessable by the model is retrieved and applied to each feature value to generate a prediction result. In a case where the prediction result does not match the known outcome, the weightages applied to the feature values will be adjusted across all positive and negative samples such that such that the prediction results are able to match all labels with known outcomes of the training data.

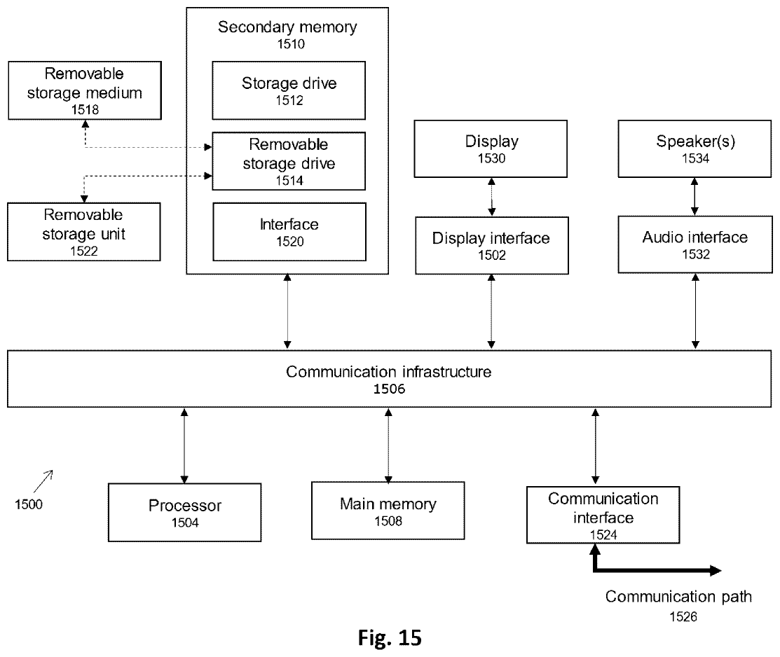

FIG. 14 shows a flowchart 1400 illustrating a rule-based process for predicting whether a person is wearing a PPE according to an embodiment of the present disclosure. In step 1402, a step of capturing video frames from a video image is caried out. In step 1404, a step of detecting and tracking a person from the video frames is carried out. In step 1406, a step of detecting and tracking a PPE from the video frames is carried out. In step 1408, a step of determining whether all tracks (or tracking trajectories) have been processed. If all tracks have been processed, step 1414 is carried out; if all tracks have not been processed, step 1410 is carried out. In step 1410, it is determined whether the person corresponding to the track which has not yet been processed is wearing PPE. This may be determined based on trajectory similarity, area overlapping and occurrence probability, as shown in step 908. If it is detected or a prediction result is generated showing the person is wearing PPE, step 1412 is carried out. In step 1412, a PPE wearing detection count is incremented by 1. If a prediction result is generated showing the person is not wearing PPE, the PPE wearing detection count is not incremented, and the process returns to step 1408.

In step 1414, it is determined that if there is any track ended. If there is a track ended, step 1416 is carried out; otherwise step 1420 is carried out. In step 1416, it is then determined if the PPE wearing detection count for this track is less than X, where X is a predetermined number of PPE. In one example, such predetermined number of PPE (X) corresponds to a number of persons detected from the video frames. If the PPE wearing detection count is less than X, step 1418 is carried out where an alert is sent to the user. If the PPE wearing detection count is equal or larger than the person count, the process returns to step 1420. In step 1420, it is determined whether it is required to stop the processing. If it is determined that it is not required to stop the processing, for example, no stop command is detected, step 1402 is again carried out to capture new video images to process through steps 1404-1416. If it is determined that a stop command is detected and thus it is required to stop the processing, the process may end.

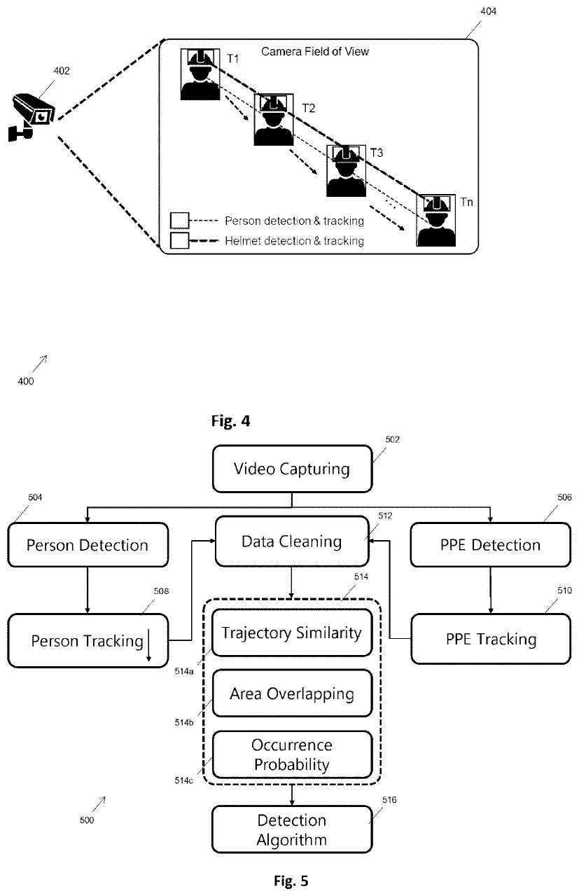

FIG. 15 shows a schematic diagram of an exemplary computing device 1500, hereinafter interchangeably referred to as a computer system 1500, where one or more such computing device 1500 may be used or suitable for use to execute the method in FIG. 2 and implement the apparatus in FIG. 3. The following description of the computing device 1500 is provided by way of example only and is not intended to be limiting.

As shown in FIG. 15, the example computing device 1500 includes a processor 1504 for executing software routines. Although a single processor is shown for the sake of clarity, the computing device 1500 may also include a multi-processor system. The processor 1504 is connected to a communication infrastructure 1506 for communication with other components of the computing device 1500. The communication infrastructure 1506 may include, for example, a communications bus, cross-bar, or network.

The computing device 1500 further includes a main memory 1508, such as a random access memory (RAM), and a secondary memory 1510. The secondary memory 1510 may include, for example, a storage drive 1512, which may be a hard disk drive, a solid state drive or a hybrid drive and/or a removable storage drive 1514, which may include a magnetic tape drive, an optical disk drive, a solid state storage drive (such as a USB flash drive, a flash memory device, a solid state drive or a memory card), or the like. The removable storage drive 1514 reads from and/or writes to a removable storage medium 1518 in a well-known manner. The removable storage medium 1518 may include magnetic tape, optical disk, non-volatile memory storage medium, or the like, which is read by and written to by removable storage drive 1514. As will be appreciated by persons skilled in the relevant art(s), the removable storage medium 1518 includes a computer readable storage medium having stored therein computer executable program code instructions and/or data.

In an alternative implementation, the secondary memory 1510 may additionally or alternatively include other similar means for allowing computer programs or other instructions to be loaded into the computing device 1500. Such means can include, for example, a removable storage unit 1522 and an interface 1520. Examples of a removable storage unit 1522 and interface 1520 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1522 and interfaces 1520 which allow software and data to be transferred from the removable storage unit 1522 to the computer system 1500.

The computing device 1500 also includes at least one communication interface 1524. The communication interface 1524 allows software and data to be transferred between computing device 1500 and external devices via a communication path 1526. In various embodiments of the disclosures, the communication interface 1524 permits data to be transferred between the computing device 1500 and a data communication network, such as a public data or private data communication network. The communication interface 1524 may be used to exchange data between different computing devices 1500 which such computing devices 1500 form part an interconnected computer network. Examples of a communication interface 1524 can include a modem, a network interface (such as an Ethernet card), a communication port (such as a serial, parallel, printer, GPIB, IEEE 1394, RJ45, USB), an antenna with associated circuitry and the like. The communication interface 1524 may be wired or may be wireless. Software and data transferred via the communication interface 1524 are in the form of signals which can be electronic, electromagnetic, optical or other signals capable of being received by communication interface 1524. These signals are provided to the communication interface via the communication path 1526.

As shown in FIG. 15, the computing device 1500 further includes a display interface 1502 which performs operations for rendering images to an associated display 1530 and an audio interface 1532 for performing operations for playing audio content via associated speaker(s) 1534.

As used herein, the term “computer program product” may refer, in part, to removable storage medium 1518, removable storage unit 1522, a hard disk installed in storage drive 1512, or a carrier wave carrying software over communication path 1526 (wireless link or cable) to communication interface 1524. Computer readable storage media refers to any non-transitory, non-volatile tangible storage medium that provides recorded instructions and/or data to the computing device 1500 for execution and/or processing. Examples of such storage media include magnetic tape, CD-ROM, DVD, Blu-ray Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1500. Examples of transitory or non-tangible computer readable transmission media that may also participate in the provision of software, application programs, instructions and/or data to the computing device 1500 include radio or infra-red transmission channels as well as a network connection to another computer or networked device, and the Internet or Intranets including e-mail transmissions and information recorded on Websites and the like.

The computer programs (also called computer program code) are stored in main memory 1508 and/or secondary memory 1510. Computer programs can also be received via the communication interface 1524. Such computer programs, when executed, enable the computing device 1500 to perform one or more features of embodiments discussed herein. In various embodiments, the computer programs, when executed, enable the processor 1504 to perform features of the above-described embodiments. Accordingly, such computer programs represent controllers of the computer device 1500.

Software may be stored in a computer program product and loaded into the computing device 1500 using the removable storage drive 1514, the storage drive 1512, or the interface 1520. The computer program product may be a non-transitory computer readable medium. Alternatively, the computer program product may be downloaded to the computer system 1500 over the communications path 1526. The software, when executed by the processor 1504, causes the computing device 1500 to perform the necessary operations to execute the method as shown in FIG. 2 and implement the apparatus in FIG. 3.

It is to be understood that the embodiment of FIG. 15 is presented merely by way of example to explain the operation and structure of the apparatus 300. Therefore, in some embodiments one or more features of the computing device 1500 may be omitted. Also, in some embodiments, one or more features of the computing device 1500 may be combined together. Additionally, in some embodiments, one or more features of the computing device 1500 may be split into one or more component parts.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

For example, the whole or part of the exemplary embodiments disclosed above can be described as, but not limited to, the following supplementary notes.

### (Supplementary Note 1)

A method for predicting whether a person is wearing a protective equipment, the method comprising:
identifying at least one feature between a person and a protective equipment in connection with the person based on appearances of the person and the protective equipment detected within a monitoring area corresponding to a field of view of an image capturing apparatus over a time period; and
generating a prediction result on whether the person is wearing the protective equipment based on the at least one feature.

### (Supplementary Note 2)

The method of supplementary note 1, wherein the identifying the at least one feature between the person and the protective equipment comprises:
detecting a first trajectory of the person and a second trajectory of the protective equipment within the monitoring area based on the appearances of the person and the protective equipment over the time period;
determining a level of similarity between the first and second trajectories, wherein the prediction result is generated based on the level of similarity.

### (Supplementary Note 3)

The method of supplementary note 1 or 2, wherein the identifying the at least one feature between the person and the protective equipment comprises: calculating a probability relating to an appearance frequency of each of the person and the protective equipment based on a first count of appearances of the person and a second count of appearance of the protective equipment within the monitoring area over the time period, wherein the prediction result is generated based on the probability.

### (Supplementary Note 4)

The method of any one of supplementary notes 1 to 3, wherein the identifying the at least one feature between the person and the protective equipment comprises:
determining if an overlapping area between the person and the protective equipment is at or close to a body part of the person, wherein the prediction result is generated based on a result of the determination of the overlapping area.

### (Supplementary Note 5)

The method of any one of supplementary notes 1 to 4, further comprising: applying a weightage to a value of each of the at least one feature, wherein the prediction result is generated based on the weighted value of the each of the at least one feature.

### (Supplementary Note 6)

The method of supplementary note 5 further comprising:
receiving a training value of the each of the at least one feature between a known person and a protective equipment in connection with the known person and a label indicating whether the known person is wearing the protective equipment;
applying an initial weightage to the training value;
generating an initial prediction result based on the weighted training value;
determining if the initial prediction result matches the label; and
adjusting the initial weightage to the weightage to be applied to the value of the each of the at least one feature in response to a result of the determination of the initial prediction result.

### (Supplementary Note 7)

The method of any one of supplementary notes 1 to 6, further comprising:
increasing a count of protective equipment detected over the time period based on the prediction result;
determining if the count of protective equipment is less than a predetermined number of protective equipment over the time period; and
generating an alert in response to determining the count of protective equipment is less than the predetermined number of protective equipment over the time period.

### (Supplementary Note 8)

An apparatus for predicting whether a person is wearing a protective equipment comprising:
at least one processor; and
at least one memory including computer program code;
the at least one memory and the computer program code configured to, with at least one processor, cause the apparatus at least to:
identify at least one feature between a person and a protective equipment in connection with the person based on appearances of the person and the protective equipment detected within a monitoring area corresponding to a field of view of an image capturing apparatus over a time period; and
generate a prediction result on whether the person is wearing the protective equipment based on the at least one feature.

### (Supplementary Note 9)

The apparatus of supplementary note 8, wherein the at least one memory and the computer program code configured to, with at least one processor, cause the apparatus at least to:
detect a first trajectory of the person and a second trajectory of the protective equipment within the monitoring area based on the appearances of the person and the protective equipment;
determine a level of similarity between the first and second trajectories.
generate the prediction result based on the level of similarity.

### (Supplementary Note 10)

The apparatus of supplementary note 8 or 9, wherein the at least one memory and the computer program code configured to, with at least one processor, cause the apparatus at least to:
calculate a probability relating to an appearance frequency of each of the person and the protective equipment based on a first count of appearances of the person and a second count of appearance of the protective equipment within the monitoring area over the time period; and
generate the prediction result based on the probability.

### (Supplementary Note 11)

The apparatus of any one of supplementary notes 8 to 10, wherein the at least one memory and the computer program code configured to, with at least one processor, cause the apparatus at least to:
determine if an overlapping area between the person and the protective equipment is at or close to a body part of the person; and
generate the prediction result based on a result of the determination of the overlapping area.

### (Supplementary Note 12)

The apparatus of any one of supplementary notes 8 to 11, wherein the at least one memory and the computer program code configured to, with at least one processor, cause the apparatus at least to:
apply a weightage to a value of each of the at least one feature; and
generate the prediction result based on the weighted value of the each of the at least one feature.

### (Supplementary Note 13)

The apparatus of any one of supplementary notes 8 to 12, wherein the at least one memory and the computer program code configured to, with at least one processor, cause the apparatus at least to:
receive a training value of the each of the at least one feature between a known person and a protective equipment in connection with the known person and a label indicating whether the known person is wearing the protective equipment;
apply an initial weightage to the training value;
generate an initial prediction result based on the weighted training value;
determine if the initial prediction result matches the label; and
adjust the initial weightage to the weightage to be applied to the value of the each of the at least one feature in response to a result of the determination of the initial prediction result.

### (Supplementary Note 14)

The apparatus of any one of supplementary notes 8 to 13, wherein the at least one memory and the computer program code configured to, with at least one processor, cause the apparatus at least to:
increase a count of protective equipment detected over the time period based on the prediction result;
determine if the count of protective equipment is less than a predetermined number of protective equipment over the time period; and
generate an alert in response to determining the count of protective equipment is less than the predetermined number of protective equipment over the time period.

### (Supplementary Note 15)

A system for predicting whether a person is wearing a protective equipment comprising the apparatus of any one of supplementary notes 8 to 14 and an image capturing apparatus with a field of view corresponding to the monitoring area within which the appearances of the person and the protective equipment are detected.

This application is based upon and claims the benefit of priority from Singapore Patent Application 10202301485T, filed on May 25, 2023, the disclosure of which is incorporated herein in its entirety by reference.

### REFERENCE SIGNS LIST

102 CAMERA
104 PERSON
106 VISION ANALYSIS MODEL
108 PPE WEARING CHECK RESULT
300 SYSTEM
302 IMAGE CAPTURING DEVICE
304 APPARATUS
306 PROCESSOR
308 MEMORY
310 DATABASE
402 CAMERA
404 MONITORING AREA
702 PERSON BOUNDING BOX
704 PPE BOUNDING BOX
1500 COMPUTING DEVICE
1502 DISPLAY INTERFACE
1504 PROCESSOR
1506 COMMUNICATION INFRASTRUCTURE
1508 MAIN MEMORY
1510 SECONDARY MEMORY
1512 STORAGE DRIVE
1514 REMOVABLE STORAGE DRIVE
1518 REMOVABLE STORAGE MEDIUM
1520 INTERFACE
1522 REMOVABLE STORAGE UNIT
1524 COMMUNICATION INTERFACE
1526 COMMUNICATION PATH
1530 DISPLAY
1532 AUDIO INTERFACE
1534 SPEAKER

What is claimed is:

1. A method for predicting whether a person is wearing a protective equipment, the method comprising:
identifying at least one feature between a person and a protective equipment in connection with the person based on appearances of the person and the protective equipment detected within a monitoring area corresponding to a field of view of an image capturing apparatus over a time period; and
generating a prediction result on whether the person is wearing the protective equipment based on the at least one feature.

2. The method of claim 1, wherein the identifying the at least one feature between the person and the protective equipment comprises:
detecting a first trajectory of the person and a second trajectory of the protective equipment within the monitoring area based on the appearances of the person and the protective equipment over the time period;
determining a level of similarity between the first and second trajectories, wherein the prediction result is generated based on the level of similarity.

3. The method of claim 1, wherein the identifying the at least one feature between the person and the protective equipment comprises:
calculating a probability relating to an appearance frequency of each of the person and the protective equipment based on a first count of appearances of the person and a second count of appearance of the protective equipment within the monitoring area over the time period, wherein the prediction result is generated based on the probability.

4. The method of claim 1, wherein the identifying the at least one feature between the person and the protective equipment comprises:
determining if an overlapping area between the person and the protective equipment is at or close to a body part of the person, wherein the prediction result is generated based on a result of the determination of the overlapping area.

5. The method of claim 1, further comprising:
applying a weightage to a value of each of the at least one feature, wherein the prediction result is generated based on the weighted value of the each of the at least one feature.

6. The method of claim 5 further comprising:
receiving a training value of the each of the at least one feature between a known person and a protective equipment in connection with the known person and a label indicating whether the known person is wearing the protective equipment;
applying an initial weightage to the training value;
generating an initial prediction result based on the weighted training value;
determining if the initial prediction result matches the label; and
adjusting the initial weightage to the weightage to be applied to the value of the each of the at least one feature in response to a result of the determination of the initial prediction result.

7. The method of claim 1, further comprising:
increasing a count of protective equipment detected over the time period based on the prediction result;
determining if the count of protective equipment is less than a predetermined number of protective equipment over the time period; and
generating an alert in response to determining the count of protective equipment is less than the predetermined number of protective equipment over the time period.

8. An apparatus for predicting whether a person is wearing a protective equipment comprising:
at least one processor; and
at least one memory including computer program code;
the at least one memory and the computer program code configured to, with at least one processor, cause the apparatus at least to:
identify at least one feature between a person and a protective equipment in connection with the person based on appearances of the person and the protective equipment detected within a monitoring area corresponding to a field of view of an image capturing apparatus over a time period; and
generate a prediction result on whether the person is wearing the protective equipment based on the at least one feature.

9. The apparatus of claim 8, wherein the at least one memory and the computer program code configured to, with at least one processor, cause the apparatus at least to:
detect a first trajectory of the person and a second trajectory of the protective equipment within the monitoring area based on the appearances of the person and the protective equipment;
determine a level of similarity between the first and second trajectories.
generate the prediction result based on the level of similarity.

10. The apparatus of claim 8, wherein the at least one memory and the computer program code configured to, with at least one processor, cause the apparatus at least to:
calculate a probability relating to an appearance frequency of each of the person and the protective equipment based on a first count of appearances of the person and a second count of appearance of the protective equipment within the monitoring area over the time period; and
generate the prediction result based on the probability.

11. The apparatus of claim 8, wherein the at least one memory and the computer program code configured to, with at least one processor, cause the apparatus at least to:
determine if an overlapping area between the person and the protective equipment is at or close to a body part of the person; and
generate the prediction result based on a result of the determination of the overlapping area.

12. The apparatus of claim 8, wherein the at least one memory and the computer program code configured to, with at least one processor, cause the apparatus at least to:
apply a weightage to a value of each of the at least one feature; and
generate the prediction result based on the weighted value of the each of the at least one feature.

13. The apparatus of claim 8, wherein the at least one memory and the computer program code configured to, with at least one processor, cause the apparatus at least to:
receive a training value of the each of the at least one feature between a known person and a protective equipment in connection with the known person and a label indicating whether the known person is wearing the protective equipment;
apply an initial weightage to the training value;
generate an initial prediction result based on the weighted training value;
determine if the initial prediction result matches the label; and
adjust the initial weightage to the weightage to be applied to the value of the each of the at least one feature in response to a result of the determination of the initial prediction result.

14. The apparatus of claim 8, wherein the at least one memory and the computer program code configured to, with at least one processor, cause the apparatus at least to:
increase a count of protective equipment detected over the time period based on the prediction result;
determine if the count of protective equipment is less than a predetermined number of protective equipment over the time period; and
generate an alert in response to determining the count of protective equipment is less than the predetermined number of protective equipment over the time period.

15. A system for predicting whether a person is wearing a protective equipment comprising the apparatus of claim 8 and an image capturing apparatus with a field of view corresponding to the monitoring area within which the appearances of the person and the protective equipment are detected.
